(19) United States
(12) Patent Application Publication
(10) Pub. No.: US 2016/0354682 A1
(43) Pub. Date: Dec. 8, 2016

(54) Three Dimensional Character Dice, Game and Method of Making

(71) Applicant: Brian Kelly Edwards, Erie, PA (US)

(72) Inventor: Brian Kelly Edwards, Erie, PA (US)

(21) Appl. No.: 14/733,802

(22) Filed: Jun. 8, 2015

(51) Int. Cl. A63F 9/04

(52) U.S. Cl. CPC A63F 9/0415; A63F 2009/0484; A63F 2009/0497; B33Y 80/00

(57) ABSTRACT

3D character dice provide game pieces of a novel game requiring no board and fitting easily in a compact carrying case. The dice can take one of many forms and may have any even number of sides from 4 to 20 and may develop into a collectible set of characters. A boardless game having game-directive cards which are tied to the differing faces of the character die is also disclosed.

This utility patent application claims priority benefit of provisional pat. appl. Ser. No. 62/069,185 filed Oct. 27, 2014 which is hereby incorporated by reference.

### BACKGROUND AND SUMMARY OF THE INVENTION

The present invention is directed to the field of amusement devices. More particularly, the present invention is directed to three-dimensional dice and to a game which can be played with those dice.

Typical board games utilize conventional hexahedral dice having pips, numbers, or icons on the side. In some such games, miniature characters are utilized as game pieces, in addition to the dice. While, generally, board games have given way to electronic games due to the ease of transport and the wide variety of games available, for the most part, the electronic games take the camaraderie and one-on-one (or one vs several) competition off the table, as most electronic games tend to be man/woman against machine.

It is among the purposes of this invention to provide a simplified game which requires no board to play allowing it to be readily carried in a compact case designed therefor, thereby reinstating the personal touch to competition. In addition, these dice can depict exotic characters and, thus, become collectibles, as well as game-functioning dice. The particular designs suggested herein are exemplary of the types of characters which can be included and these designs readily lend themselves to this type of competition. Further, the three-dimensional character dice of the present invention may take any form desired and, with appropriate permission from copyright holders, may emulate famous/popular characters, real or imaginary. While typically people envision dice as having 6 sides, the dice of the present invention may have any even number from 4 to 20 sides without departing from the scope of the invention. Lastly, it is envisioned that these may be “transformer” dice, i.e., have hinged/removable parts which enhance characterization that are then folded/replaced back into the body for functioning as a die.

Traditionally, dice have taken the form of flat-sided cubes (hexahedrons) which have no real interest in themselves and, hence, can readily lead to disinterest in the game, particularly, should the dice not be rolling one's way. The three-dimensional character dice of the present invention maintain their interesting configuration with each side depicting a facet of the character and, as suggested previously, can be displayed as part of a collection when not “gamefully employed”.

Recent technological advances have made such dice more readily produced. The proposed methodology of manufacture would employ a 3D printer to formulate a model of the appropriate character shape. The model would then be utilized to form a reverse image mold and the end pieces then cast using a thermoplastic or thermoset resin.

The present invention is directed to a three-dimensional character die comprising a) a generally polygonally-shaped element, the polygonally-shaped element configured as a three-dimensional character for use as a die in a dice-rolling game, the three-dimensional character having a plurality ‘x’ of variously configured, non-planar sides; b) at least some of the plurality ‘x’ of variously configured, non-planar sides having maximum protruding extents lying in a plurality of ‘n’ different planes, wherein ‘n’>2. The value of ‘x’ is preferably in the range of between 4 and 20. Further, at least x−1 of said variously configured sides have completely unique configurations. It is also preferred that the number ‘n’ of different planes is ≧4. The dice of the present invention is preferably made by a process including the steps of a) forming a model using 3D printing; b) creating a fillable mold using said model; c) filling the fillable mold with a material to form the character die, the material being selected from a group consisting of thermoset resins and thermoplastic resins.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1A is a front perspective view of a first embodiment of the 3D character dice of the present invention configured as a fanciful mummy;

FIG. 1B is a front view of the embodiment shown in FIG. 1A;

FIG. 1C is a rear view of the first embodiment;

FIG. 1D is a bottom view of the first embodiment;

FIG. 1E is a view of the left side of the first embodiment;

FIG. 1F is a top view of the first embodiment;

FIG. 2 is a front perspective view of a second embodiment configured as a boogie man;

FIG. 3 is a front perspective view of a third embodiment configured as an alien;

FIG. 4 a front perspective view of a fourth embodiment configured as a yeti;

FIG. 5 is a front perspective view of a fifth embodiment configured as Frankenstein;

FIG. 6 is a front perspective view of a sixth embodiment configured as a ghost;

FIG. 7 is a front perspective view of a seventh embodiment configured as a vampire;

FIG. 8 is a front perspective view of a eighth embodiment configured as a werewolf;

FIG. 9A is a front perspective of one configuration of carrying case for the dice of the present invention with the top open;

FIG. 9B is a front perspective similar to FIG. 9A with the top closed;

FIG. 10A is a top view of a Cthulu, a character having four sides;

FIG. 10B is a front perspective view of the Cthulu of FIG. 10A;

FIG. 10C is a front view of the Cthulu;

FIG. 10D is a side view of the Cthulu;

FIG. 11A is a front perspective view of a block having ten sides;

FIG. 11B is a front perspective view of a demon hunter having ten sides;

FIG. 11C is a front view of the character shown in FIG. 11B;

FIG. 11D is a side view of the character depicted in FIG. 11B;

FIG. 12A is a three-quarter front perspective of a Cerberus having 12 sides;

FIG. 12B is front view of the character shown in FIG. 12A;

FIG. 12C is a top view of the character shown in FIG. 12A;

FIG. 12D is a bottom view of the character shown in FIG. 12A;

FIG. 12E is a rear view of the character shown in FIG. 12A;

FIG. 12F is a side view of the character shown in FIG. 12A;

FIG. 13A is a three-quarter view of a dragon having 20 sides;

FIG. 13B is a rear view of the character shown in FIG. 13A;

FIG. 13C bottom view of the character shown in FIG. 13A;

FIG. 13D is a front view of the character shown in FIG. 13A;

FIG. 13E is a side view of the character shown in FIG. 13A;

FIG. 13F is a top view of the character shown in FIG. 13A;

FIG. 14A is an example of a backup card; and,

FIG. 14B is an example of a character card.

### DETAILED DESCRIPTION OF THE PREFERRED EMBODIMENT(S)

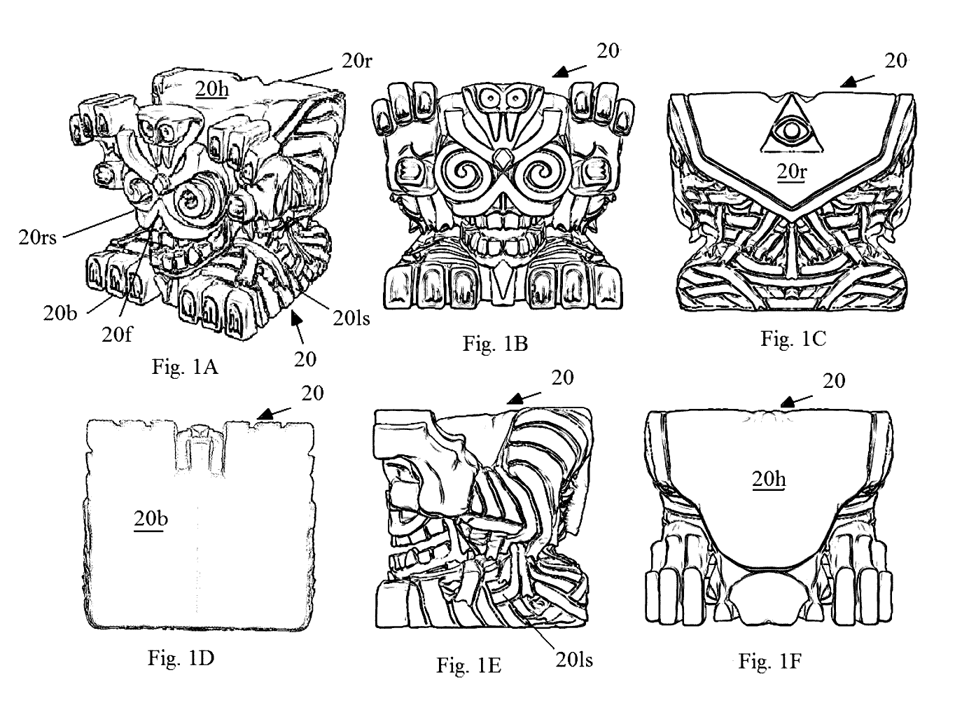

A first embodiment of the character die of the present invention is depicted in FIGS. 1A-1E generally at 20. In this first embodiment, the polygonal die is configured as a conventional hexahedron (six-sided) die embodied as a mummy. For this character, 20h is the head, 20b is the base, 20f is the face, 20r is the rear, 20rs is the right side and 20ls is the left side. Although shown larger to depict the details of the various profiles, the die 20 will typically be on the order of a 1″ cube (or alternate shape). Unlike conventional six-sided dice, the character die of the present invention has non-planar sides with ‘n’ lateral (or vertical) extents (variations in projection from a base level), with n being >2. More preferably, for at least some of the plurality of ‘x’ sides, the number of lateral extents exceeds 4. It will be appreciated that while the conventional hexahedron shape of die is shown, it is within the scope of the present invention for the number of sides to be any even number in the range of between 4 and 20. When a particular side of the die is rolled to the face-up position, it will control the type of move/provision provided on that roll.

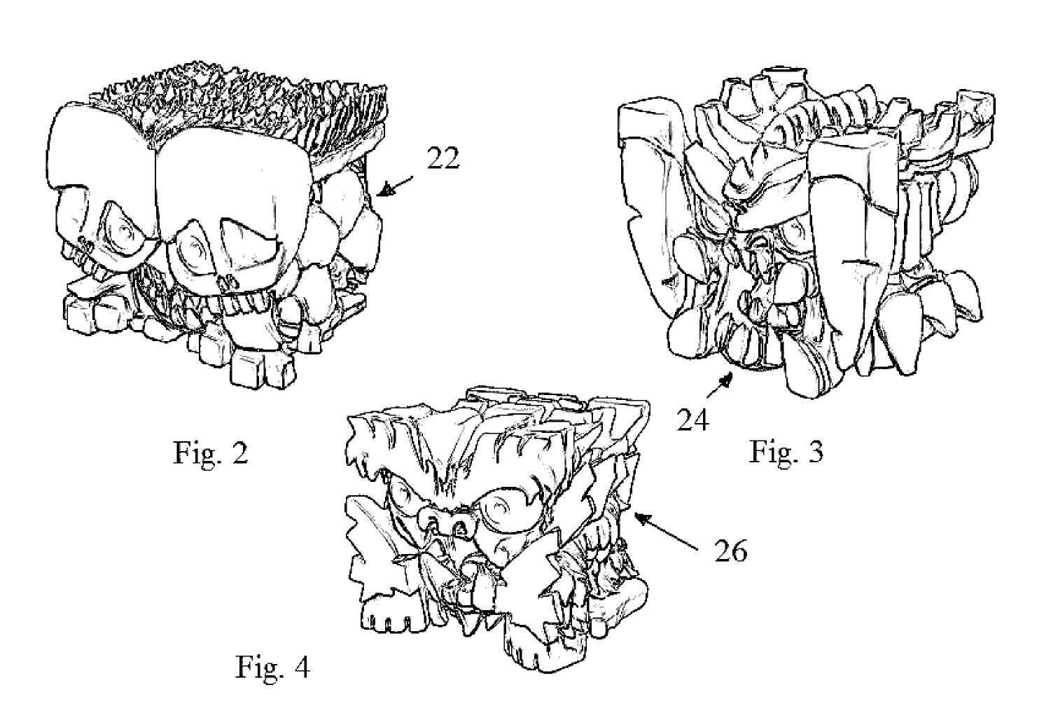

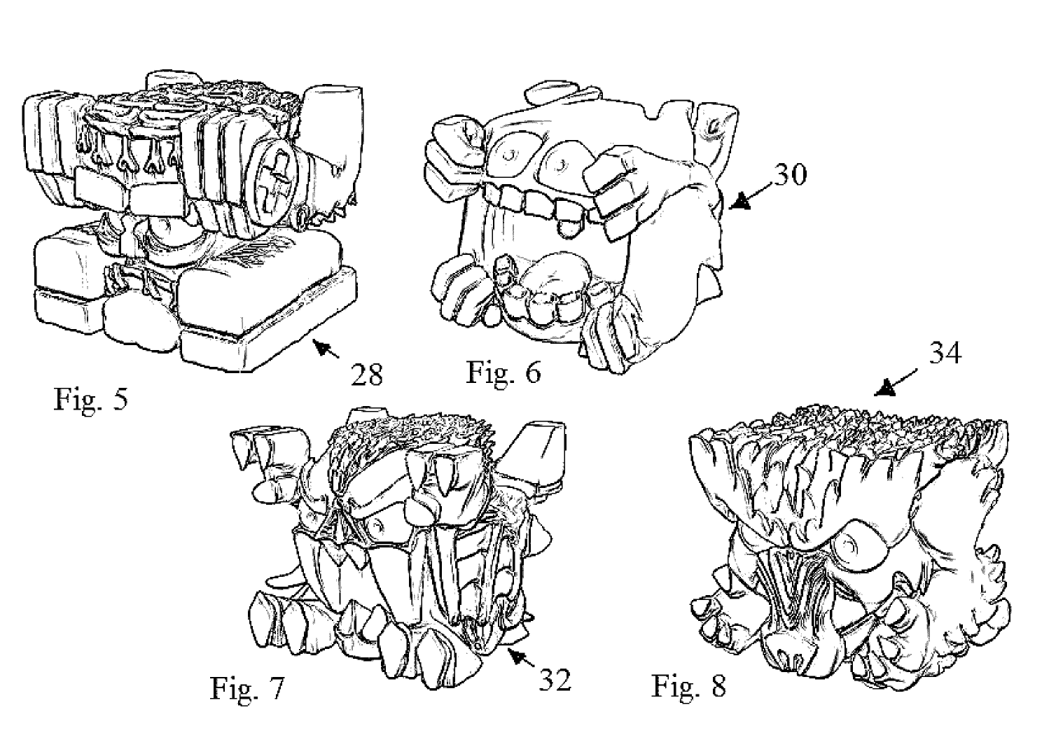

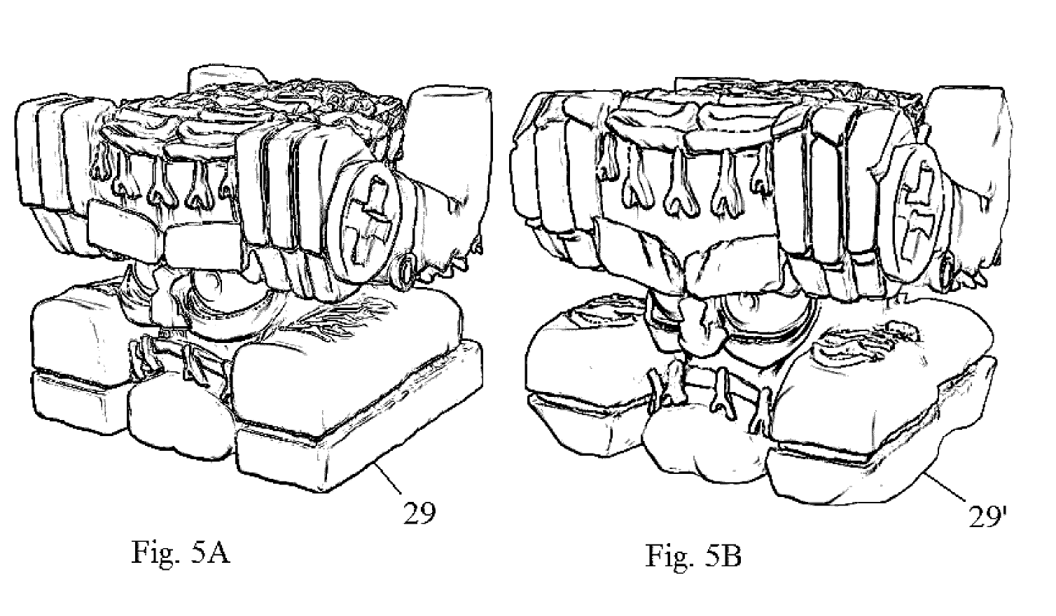

As has been noted, the character die of the present invention may be configured to represent any character desired. To substantiate that allegation, FIG. 2 depicts a boogie man at 22; FIG. 3, an alien at 24; FIG. 4, a yeti at 26; FIG. 5, Frankenstein at 28; FIG. 6, a ghost at 30; FIG. 7, a vampire at 32; and FIG. 8, a werewolf at 34. These figures are exemplary of the types of characters which are envisioned in conjunction with the present invention. Formerly, creating such shapes would require expensive carving techniques that would render creating such characters cost prohibitive for all but the well-to-do collectors. With the advent of 3D printing technology, a model can be formed, used to make a negative cavity mold and then, mass produced by filling the mold with a thermoset, or thermoplastic resins to include various elastomers, natural and man-made rubbers. In addition, it is envisioned that an iridescent pigment or other coloration could be added to the moldable material to make it glow in the dark. Further, it is within the scope of the invention to paint the die once it is formed to highlight the 3D features.

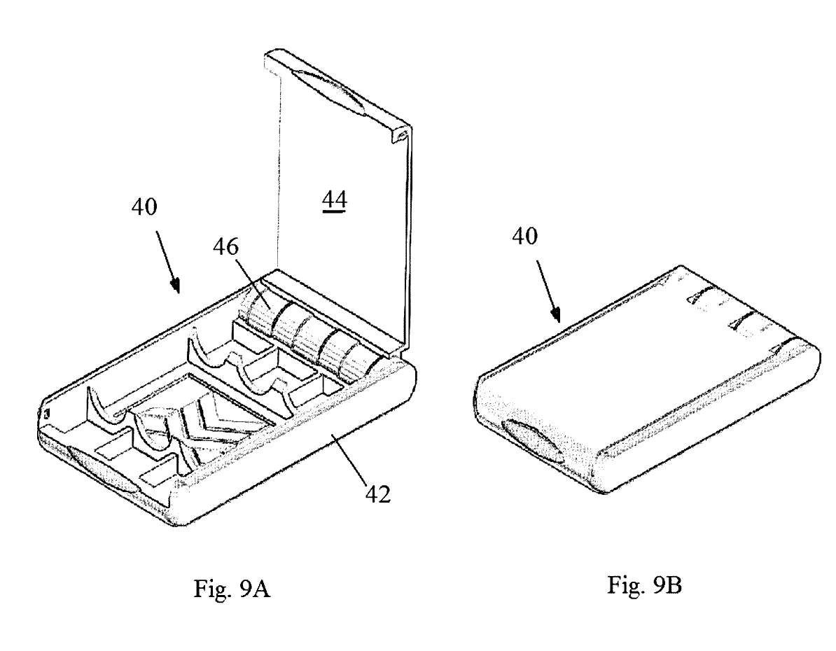

FIGS. 9A and 9B depict a carrying case 40 which permits several sets of character dice of the present invention to be easily transported. Carrying case 40 is comprised of a bottom with several chambers for receiving individual dice. Cover 44 is connected to base 42 by hinge 46. It will be appreciated that the depiction of carrying case 40 is simply exemplary. Configuration changes may be implemented to reduce plastic utilized in the construction by shrinking the size of the members from base 42 and cover 44 in hinge 46 and using a simple through rod as the actual hinge element.

Other variations are possible with regard to any of the characters. For example, it is envisioned that completely square edges will tend to make the dice slide on the playing surface, whereas, rounded corners will facilitate the rolling motion desired for game dice. As shown in FIGS. 5A and 5B, the edges 29 of the Frankenstein character 28 may be rounded as at 29′ in FIG. 5B. As can be seen by comparing these two figures, this rounding has a tendency to “soften” the features of the character. It will be appreciated that this adaptation may be applied to any of the characters shown or others which may be envisioned.

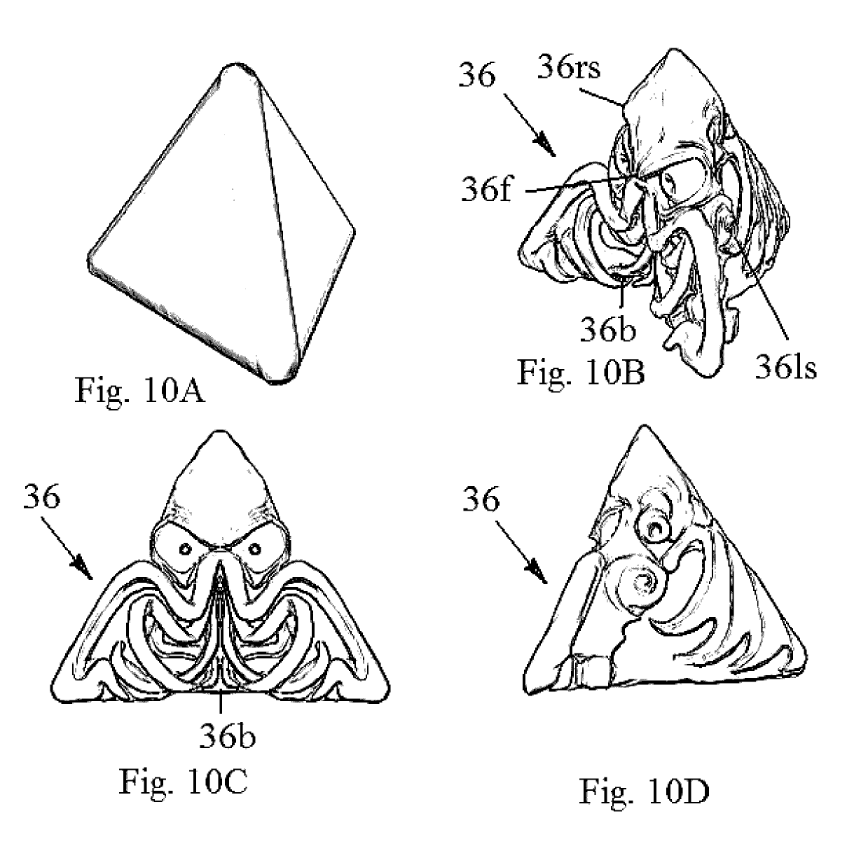

In addition to the traditional hexahedronally shaped dice, the 3-D character dice of the present invention may have any even number of sides between 4 and 20. The Cthulu depicted in FIGS. 10A-10D comprise a four-sided character dice 36 having left side 36ls, right side 36rs, front face 36f, and bottom 36b.

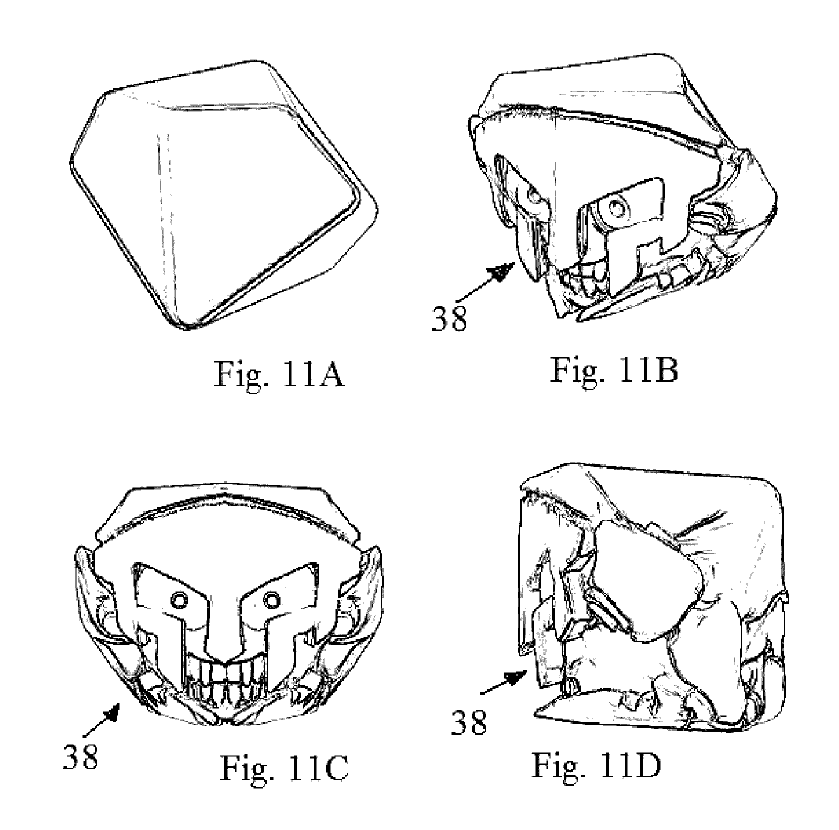

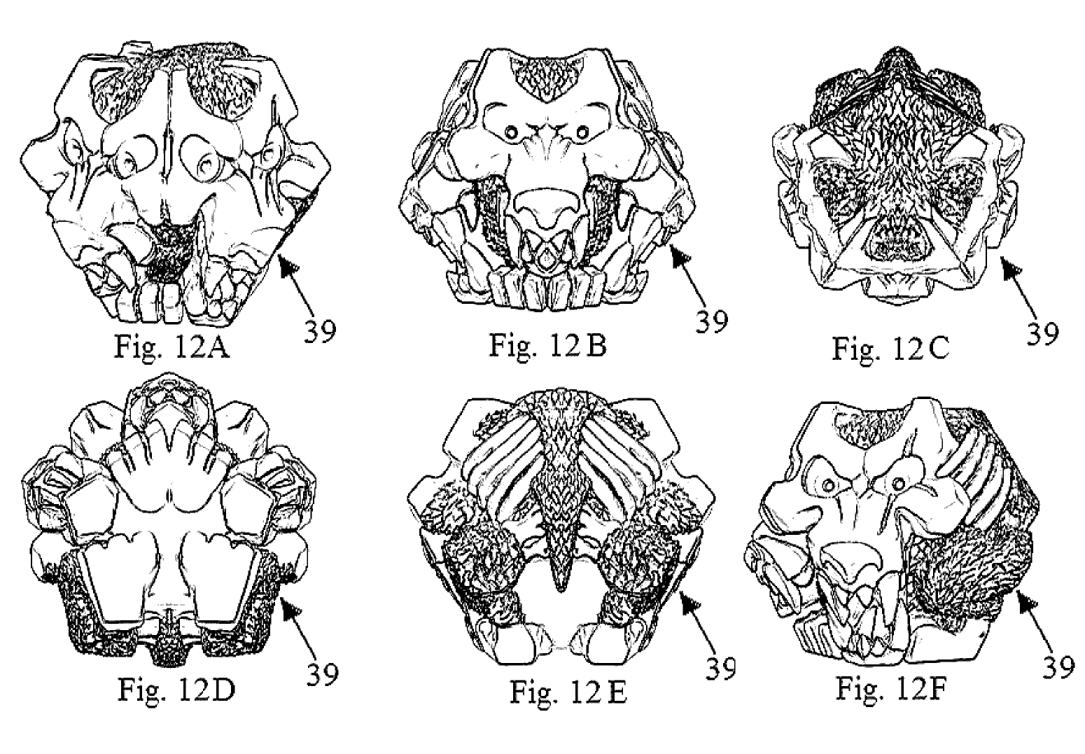

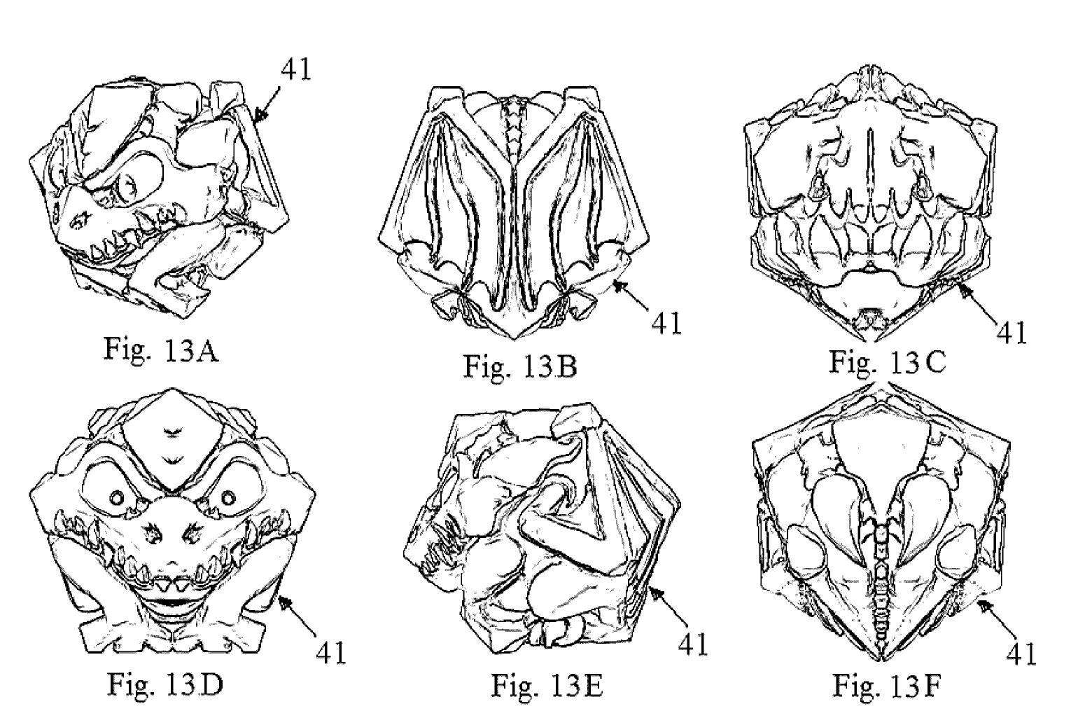

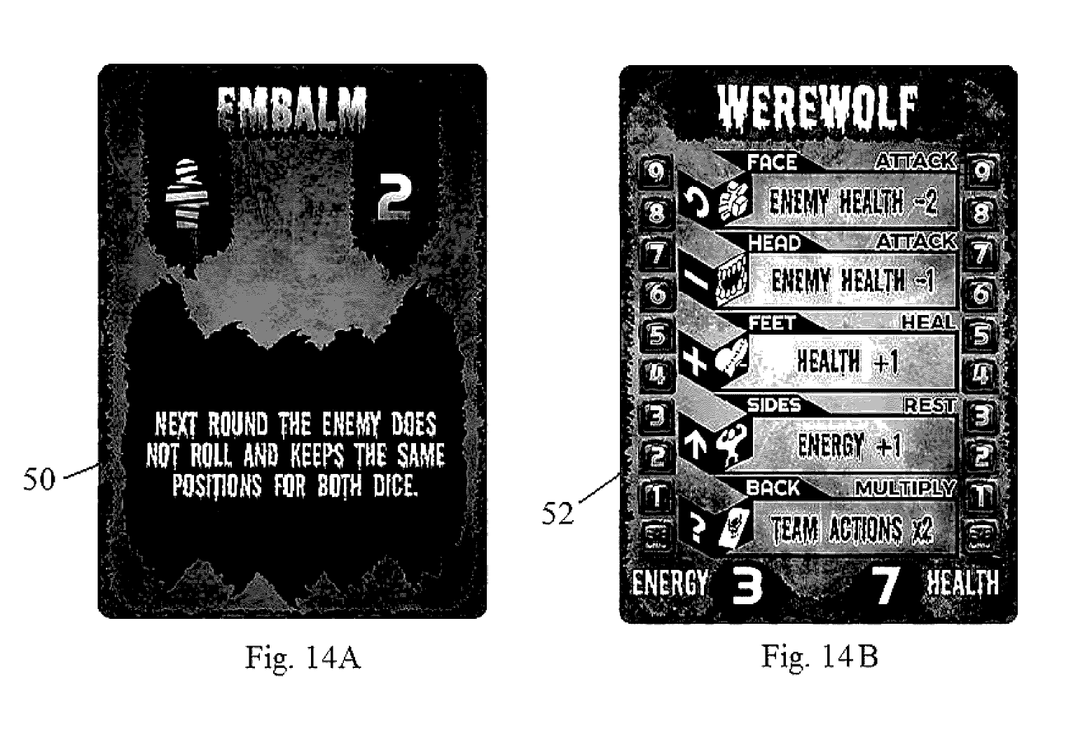

FIG. 11A shows the configuration of a block with ten equilateral sides. FIGS. 11B-D show a demon hunter generally at 38. FIGS. 12A-F depict a character configured as a Cerberus generally at 39 having 12 sides. FIGS. 13A-13F represent a 20-sided dragon generally at 41.

While the dies that have been described have been shown for use in a “real world” game, it will be appreciated the features of the present invention are equally adapted (perhaps, even better suited) for use in a “virtual world”, i.e, an electronic video game. It is intended that “character” include the concept of vehicles, buildings, as well as 3-D persona, real or imaginary. With the features available with 3-D printing, a character die configured as a dragon, for example, could have wings that fold out/upward when displayed on a shelf but snap into a non-extended position when the die is used in the game.

Details of a game associated with any of the 6-sided dice follow.

### Objective:

Victory is achieved when all of the enemy characters have fallen to 0 health.

### Setup:

Players choose two character dice.
Each character comes with a combat card and a set of backup cards.
Keep track of each character's health and energy on the left and right sides of the combat cards.
Backup cards can be played when that character has enough energy to spend, the energy cost is on the top right of the backup card.

### How To Play:

Players roll character dice at the same time. After the dice have come to rest the upper surface is the dice position and controls the resultant action.
Actions for each dice position are listed on the combat card.
   Example of actions may include but are not limited to:
FACE: Deal—2 damage to one character
HEAD: Deal—1 damage to one character
FEET: Increase health+1
SIDES: Increase energy+1
BACK: Multiply your ally's action ×2
   Backup cards are held by each player as a hand of cards. If a player chooses to use a Backup card s/he places the particular card face down on the table. The actions from the backup cards are revealed and played in the order they were placed on the table after each player determines their play for the particular round.
   Example of backup card actions may include but are not limited to:
Hypnotize: Force the enemy to re-roll with their opposite hand.
Deflect: Any damage you would have taken this round will hit the attacking enemy instead.
Embalm: Next round enemy does not roll and keeps the same dice positions.

Variations of this game and rules therefor which are specific to a 3-D die having six differing sides derive for 4-sided, 8-sided, 10-sided, 12-sided, 14-sided, 16-sided, 18-sided and 20-sided character dice, as well.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

I claim:

1. A three-dimensional character die comprising:
a) a generally polygonally-shaped element, said polygonally-shaped element configured as a three-dimensional character for use as a die in a dice-rolling game, said three-dimensional character having a plurality ‘x’ of variously configured, non-planar sides;
b) at least some of said plurality ‘x’ of variously configured, non-planar sides having maximum protruding extents lying in a plurality of ‘n’ different planes, wherein ‘n’>2.

2. The three-dimensional character die of claim 1 wherein ‘x’ is an even number in the range of between 4 and 20.

3. The three-dimensional character die of claim 2 wherein at least some of said variously configured sides have completely unique configurations.

4. The three-dimensional character die of claim 1 wherein said number ‘n’ of different planes is ≧4.

5. The three-dimensional character die of claim 1 wherein said character die is made by a process including the steps of
a) forming a model using 3D printing;
b) creating a fillable mold using said model;
c) filling said fillable mold with a material to form said character die, said material being selected from a group consisting of thermoset resins and thermoplastic resins.

6. A boardless game for two or more players featuring 3-D character dice, said game comprising:
a) a plurality of differing 3-D character dice each having multiple varying facets;
b) a combat card peculiar to each differing 3-D character dice wherein said combat card lists a group of different values associated with each different facet of a die;
c) a set of backup cards provided for each player;
wherein rolling said 3-D character dice result in players receiving various values and following various directions set forth on said combat card for said peculiar character die facet and said combat card as chosen to be played by one or more players in turn in an order played during a particular round.
